(19) United States
(12) Patent Application Publication
(10) Pub. No.: US 2024/0127311 A1
(43) Pub. Date: Apr. 18, 2024

(54) SYSTEMS AND METHODS TO ANALYZE AND IDENTIFY EFFECTIVE CONTENT FOR A CURATION IN DIGITAL ENVIRONMENTS

(71) Applicant: Solsten, Inc., St. Paul, CA (US)

(72) Inventor: Joseph Jack Schaeppi, Maple Grove, MN (US)

(21) Appl. No.: 17/967,640

(22) Filed: Oct. 17, 2022

(51) Int. Cl. G06Q 30/06

(52) U.S. Cl. CPC G06Q 30/0631

(57) ABSTRACT

Systems and methods to analyze and identify effective content for a curation in digital environments are disclosed. Exemplary implementations may: receive a recommendation curation request for content from a user; receive, in an ongoing manner, new pieces of content characterized by content parameter values to content parameters that online platforms produced for the digital environments; determine, based on interaction information, a first set of the pieces of content that the user interacts within the digital environments responsive to receipt of the recommendation curation request; correlate the content parameter values for individual pieces in the first set with the psychological profile of the user; identify a curation of the pieces of content and the new pieces of content that are similar to the first set based on the psychological profile of the user, the correlations, and the new pieces of content; effectuate presentation of the curation to the user.

### FIELD OF THE DISCLOSURE

The present disclosure relates to systems and methods to analyze and identify effective content for a curation in digital environments.

### BACKGROUND

A user typically engages with multiple digital environments that all provide various content, whether similar or different. Online platforms that provide or host the digital environments may fail to provide users with content recommendations, for all the digital environments, that are appropriate for individual ones of the users and based on their previous interaction with other content and their psychological attributes. Further, there may lack a system where creators of content may request for pieces of new content to be recommended to appropriate users given the users' psychological attributes and previous interactions with other content.

### SUMMARY

One aspect of the present disclosure relates to a system configured to analyze and identify effective content for a curation in digital environments. In one aspect of the present disclosure, a recommendation curation request from a user is received so that the user receives a curation of one or more pieces of content amongst multiple online platforms appropriate for them. The system may receive new pieces of content that the individual online platforms have produced for respective digital environments, if any. Subsequently, a set of pieces of content that the user interacts with may be determined and content parameter values that define individual ones of those pieces may be determined. Those content parameter values may be correlated with a psychological profile of the user. Based on the correlations, the curation of pieces of content and/or the new pieces of content that are similar to ones previously interacted with by the user may be determined and presented to the user.

Another aspect of the present disclosure relates to the online platforms, or administrative users thereof, requesting for a new piece of content to be included in curations for appropriate users. Based on content parameter values determine for that new piece of content, similar pieces of content may be determined and correlations between the similar pieces of content and psychological profiles may be identified. Based on the correlations, particular psychological profiles may be identified so that the new piece of content may be included in curations for users associated with those psychological profiles. As such, the system may adapt curations of content for multiple platforms that are generated for their users based on the users themselves in response to requests from the users and/or providers of the content. This eliminates static digital environments and global curation that may not be suitable for all users.

The system may include one or more hardware processors configured by machine-readable instructions. The instruction components may include computer program components. The instruction components may include one or more of curation request component, content determination component, correlation component, curation component, and/or other instruction components.

The curation request component may be configured to receive a recommendation curation request for content from a client computing platform associated with a user.

The content determination component may be configured to receive, in an ongoing manner, new pieces of content that online platforms produced for the digital environments. The new pieces of content may be characterized by the content parameter values to the content parameters.

The content determination component may be configured to determine, based on the interaction information, a first set of the pieces of content that the user interacts within the digital environments responsive to receipt of the recommendation curation request.

The correlation component may be configured to correlate the content parameter values to the content parameters for individual pieces in the first set with the psychological profile of the user.

The curation component may be configured to identify a curation of the pieces of content and the new pieces of content that are similar to the first set of the pieces of content and/or are characterized with similar ones of the content parameter values based on the psychological profile of the user, the correlations, the new pieces of content, and/or other information.

The curation component may be configured to effectuate presentation of the curation to the user via a client computing platform associated with the user.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to analyze and identify effective content for a curation in digital environments, in accordance with one or more implementations.

FIG. 2 illustrates a method to analyze and identify effective content for a curation in digital environments, in accordance with one or more implementations.

FIG. 3A-B illustrates an example implementation of a system configured to analyze and identify effective content for a curation in digital environments, in accordance with one or more implementations.

### DETAILED DESCRIPTION

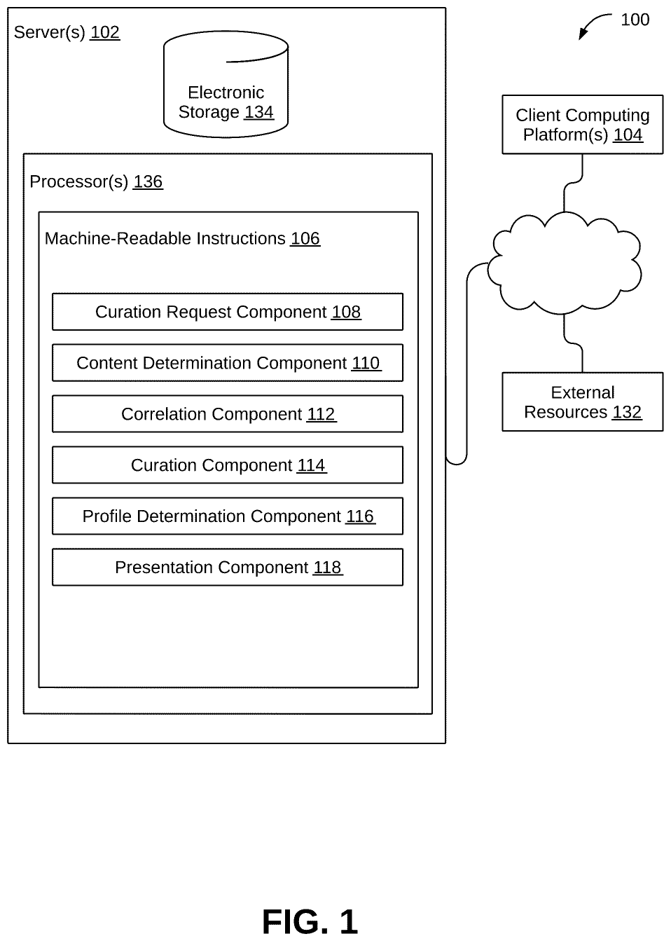

FIG. 1 illustrates a system 100 configured to analyze and identify effective content for a curation in digital environments, in accordance with one or more implementations. In some implementations, system 100 may include one or more servers 102, electronic storage 134, and/or other elements. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Electronic storage 134 may be configured to store psychological profiles for users, pieces of content provided by digital environments, interaction information, taxonomical classifications of individual ones of the pieces of content, and/or other information. In some implementations, a given psychological profile may characterize and be for a single unique user. In some implementations, the given psychological profile may characterize and be for more than one user. The psychological profiles may include the psychological parameter values to the psychological parameters. The psychological profiles may include sets of psychological parameter values to the psychological parameters for the individual users. By way of non-limiting example, the psychological parameter values of the psychological parameters may be a number score on a predetermined range unique to each psychological parameter, a letter score, and/or other type of value than may characterize a particular user as whole.

Parameters, such as psychological parameters are described herein, may specify measurable, recordable, and/or determined information. The parameter values corresponding to the parameters may be a particular value, numerical or non-numerical, that characterizes the content, the users, or respective element that the parameter value is described in relation to. The psychological parameter values may characterize a given users feelings, emotions, perceptions, thoughts, and behaviors. By way of non-limiting example, the psychological parameters values may characterize competitiveness, goal orientation, and learning style, among others.

The pieces of content may include a character, a game, a game asset, video content, image content, and/or other pieces of content. The character may refer to an object (or group of objects) present in a virtual space that corresponds to an individual user (e.g., an avatar) and/or are controlled by the user. In some implementations, the character may not correspond to an individual user but rather provide information (e.g., the recommendation, the suggestion) to the user. The game asset may include a virtual item, a virtual resource (e.g., weapon, tool), of in-game powers, in-game skills, in-game technologies, and/or other game assets.

The digital environments may be hosted by or otherwise provided by the online platforms. In some implementations, the digital environments may be accessible via applications. The applications may include mobile applications accessible via portable client computing platforms 104, desktop applications, console applications, television applications, and/or other applications. In some implementations, the online platforms may be directly accessed via web browsers and Internet, or offline. For example, the digital environments, and types thereof, may include, by way of non-limiting example, game environments, educational environments, reading environments, music interfaces, social networking environments, entertainment environments, fitness environments, business environments, shopping environments, food & drink providing environments, among others integrated or connected with system 100.

The digital environment and/or individual applications may provide simulated spaces or views of a virtual space. Individual simulated spaces may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance executed by the computer components may be synchronous, asynchronous, and/or semi-synchronous.

The interaction information may characterize interactions between the users and the pieces of content via the digital environments and/or engagement by the users with the pieces of content. The interaction information may include the content engaged with by the users, how the individual users engaged with the content, content not engaged with or avoided by the users, and/or other interaction information. In some implementations, the interaction information may identify the users. In some implementations, the interaction information may identify the psychological profiles of the users. The content engaged with by the individual users may be related to the digital environments or the individual online platforms that provide the content. That is, for example, the content provided by a digital environment may relate to online games (e.g., virtual goods, virtual mini games, etc.) the digital environment hosts. In some implementations, the content engaged with by the individual users may not be related to the digital environments that provide the content. Meaning, the content may direct the user to a different digital environment.

How the users engage with the content, or engagement by the individual users, may define behavior patterns of the individual users with or based on the content. The behavior patterns of the individual users may include individual actions, sets of actions, ordered sets of actions, time spent by the individual users engaging with the content and/or within the digital environment, spending patterns of the users, completed tasks by the individual users, uncompletion tasks by the individual users, failure of tasks by the individual users, game mechanics initiated by the users, and/or other behavior patterns. In some implementations, the behavior patterns may include multiple of the individual actions, the sets of actions, and the ordered set of actions. The actions may include one or more of a purchase based on the content, a sale, a trade, a donation, a user selection of the content, gameplay (e.g., mini-game, battle, competition, etc.) based on the content, communication of the individual users with other particular users or users, completion of tasks by the users, frequent interaction with the content, formation of alliances by the users, and/or other actions. The spending patterns may indicate an amount of currency (e.g., real-world money, virtual money, points, etc.) spend, an amount of currency earned, an amount of currency donated, and/or other indications.

The game mechanics may include alternating turns in the one or more games, action points, playing cards, capturing, catch-up progression, dice, movements, resource management, risk and reward, role-playing, game modes (e.g., single-player, multiplayer), and/or other novel or known game mechanics. In some implementations, different ones of the games and/or the content provided by the online application may employ different game mechanics. Thus, the user may initiate and utilize different game mechanics within the online application. Conversely, the user may disregard some of the game mechanics by disregarding some of the games and/or the content within the online application.

In some implementations, the interactions of the users with the digital environments and/or the behavior patterns of the users may be correlated with psychological attributes, i.e., the psychological parameter values to the psychological parameters, as described in U.S. application Ser. No. 16/894,522 entitled “SYSTEMS AND METHODS TO CORRELATE USER BEHAVIOR PATTERNS WITHIN AN ONLINE GAME WITH PSYCHOLOGICAL ATTRIBUTES OF USERS” Attorney Docket No. 01TT-064002, the disclosure of which is incorporated by reference in its entirety herein.

Individual taxonomical classifications may include content parameter values for content parameters that define classifications for the individual pieces of content. The users may be patients or people who require assistance. The taxonomical classifications may conform to a taxonomy that defines a hierarchical system of the content parameters that facilitate providing the pieces of content with the classifications. Individual taxonomical classifications may include content parameter values for content parameters that define classifications for the individual pieces of content. The taxonomical classifications may conform to a taxonomy that defines a hierarchical system of the content parameters that facilitate providing the pieces of content with the classifications. The pieces of content may be defined by the content parameter values for some or all of the content parameters.

Some of the content parameters may be high order parameters and some of the content parameters may be lower order parameters. That is, a high order parameter may include more specific lower order parameters where the content parameter values more specifically describe the content as the content parameter values exist for the lower order parameters. In some implementations, a parameter may be one or more hierarchical orders within the taxonomy. The content parameters may include genre, platform-specific genre, mechanics, theme, art style and perspective, brand intellectual property, modes, churn, marketing assets, creative elements, and/or other content parameters. Such content parameters may be the higher order parameters of the content parameters. Each of these content parameters may include one or more lower order content parameters.

A given genre may refer to a particular style, form, or set of content elements (e.g., action, adventure, sports, casino). A given platform-specific genre may a genre specific to a platform and/or real or virtual setting (e.g., arcade, music, party, racing, slots). A given mechanic may govern rules for the users and responses to actions by the users and/or actions of other pieces of content within the digital environment (e.g., physics). A given theme may refer to a particular subject or topic that the digital environment is related and developed around (e.g., crime/mystery, horror, vehicles). A given art style and perspective may refer to visual style, render technique, perspective, and/or other art styles and/or perspectives. A given brand intellectual property may refer to tangible or intangible concepts that may be afflicted with a brand (e.g., sports, game show, kids toy). A given mode may refer to a configuration of a digital environment and a role or position of the user/player within the digital environment (e.g., player-as-manager, single player, player-as-actor). A given churn may refer to how the users and/or content within the digital environment move in and out of the digital environment (e.g., deliberate). A given marketing asset may refer to an element that may facilitate promotion or presentation of a piece of content (e.g., placements, emotional drivers). A given creative element may refer to an artistic element that facilitate promotion of a piece of content (e.g., coin, flag, light bulb).

The content parameter values may be a number within a defined range (e.g., 1-10), a binary number, a letter score, a yes or no, and/or other type of value. In some implementations, the content parameter values being within a particular range may signify that multiple ones of the content parameter values are similar. For example, the content parameter values for a first content parameter may be a number within a defined range of 0-20. The content parameter values of 1-5 may be considered similar content parameter values for the first content parameter.

Server(s) 102 may be configured by machine-readable instructions 106. Machine-readable instructions 106 may include one or more instruction components. The instruction components may include computer program components. The instruction components may include one or more of curation request component 108, content determination component 110, correlation component 112, curation component 114, profile determination component 116, presentation component 118, and/or other instruction components.

Curation request component 108 may be configured to receive a recommendation curation request for content from client computing platform 104 associated with a user. The recommendation curation request from the user may be a request to receive one or more pieces of content that the user may specifically have an affinity to or otherwise enjoy. In some implementations, the recommendation curation request from the user may specify an objective of the request. The objective may specify particular content that the user requests recommendations for. The objective may include engaging content, health content, active content, multiplayer content, single player content, reoccurring content, educational content, and/or other objectives. In some implementations, the objective may specify a psychological objective, an academic objective, and/or a physical objective, and thus the content the user is requesting facilitates the psychological objective, the academic objective, and/or the physical objective. For example, the psychological objective, the academic objective, and/or the physical objective may include sobriety, physical stamina, a mile time, reading skills, math skills, and/or other psychological objectives, academic objectives, and/or physical objectives. Individual ones of the psychological objective, the academic objective, and/or the physical objective may be associated with particular pieces of content. For example, the physical stamina objective may be associated with workout content that gradually facilitate increasing physical stamina.

In some implementations, the recommendation curation request may be received in a reoccurring manner. The reoccurring manner may include every day, every month, every week, every particular amount of days, and/or other reoccurring manner. In some implementations, the user may define the reoccurring manner via their client computing platform 104. In some implementations, the reoccurring manner may be predefined by system 100 or an administrative user of system 100. Curations, described herein, responsive to every recommendation curation request may be different.

In some implementations, curation request component 108 may be configured to receive a content recommendation request from client computing platform(s) 104 associated with one or more creators of one or more pieces of new content. The one or more creators may create the new content for the online platforms and to be provided by the digital environments that the online platforms host. The content recommendation request from the creator may be a request to recommend the one or more pieces of new content to appropriate ones of the users who may have an affinity or otherwise enjoy such. The content recommendation request may include the one or more pieces of new content. The pieces of new content may include virtual content, physical products, services, subscription plans, and/or other new content not already existing in the digital environment or outside the digital environment. The virtual content may refer to the pieces of content provided in the digital environments described herein. The physical products may refer to items that the users would use in real-world contexts, such as kitchen gadgets, tools, among others. The services may refer to services that the users may consume or experience in real-world contexts such as automotive services, beauty services, among others. The subscription plans may refer to subscriptions to services and/or digital content such as meal subscription services, video streaming subscription services, cloud storage subscription services, among others.

Content determination component 110 may be configured to receive, in an ongoing manner, the one or more new pieces of content that online platforms produced for the digital environments. In some implementations, the new pieces of content may be created by one or more creators. The new pieces of content may be characterized by the content parameter values to the content parameters. The term “ongoing manner” as used herein may refer to continuing to perform an action (e.g., determine, receive) periodically (e.g., every 30 seconds, every minute, every hour, etc.) until receipt of an indication to terminate. For example, the indication to terminate may be received from the online platforms.

In some implementations, content determination component 110 may be configured to determine the content parameter values to the content parameters for the one or more pieces of new content. In some implementations, determining the content parameter values may include receiving the content parameter values from client computing platform(s) 104 associated with the one or more creators. That is, the one or more creators may define the one or more pieces of new content by providing the content parameter values to the content parameters. In some implementations, determining the content parameter values may include analyzing individual ones of pieces of the new content. Analysis of the individual pieces of the new content may include determining the existing content stored in electronic storage 134 that is similar to the pieces of new content, determining deviations in the content parameter values of the existing content for the pieces of new content, and/or analysis techniques to determine the content parameter values to the content parameters.

Content determination component 110 may be configured to determine a first set of the pieces of content that the user interacts within the digital environments. The determination of the first set may be based on the interaction information associated with the user, the psychological profile of the user, and/or other information. The determination may be responsive to receipt of the recommendation curation request from the user. The first set may include pieces of content that the interaction information identifies that the user interacts with frequently and has an affinity to. That is, given that the interaction information is associated with the user, and given that the interaction information includes the content that the user engages with, the first set may be determined.

In some implementations, content determination component 110 may be configured to determine a second set of the pieces of content that are similar to the one or more pieces of new content included in the content recommendation request. The second set may be determined based on the interaction information, the content parameter values to the content parameters that define the pieces of content that the interaction information includes, and/or other information.

Correlation component 112 may be configured to correlate the content parameter values to the content parameters for the individual pieces of content in the first set with the psychological profile of the user. In some implementations, the correlations may be between correlate the content parameter values to the content parameters for the individual pieces of content in the first set and the psychological parameter values to the psychological parameters of the user(s). That is, some of the psychological parameter values that comprise the psychological profile of the user may be correlated with the content parameter values to the content parameters for the individual pieces of content, rather than all of them. The correlations may be stored in electronic storage 134. The correlations may provide indications of what types of content the user frequently engages with and has an affinity to. Such correlations may facilitate determining new or other content with the same or similar content parameter values to the content parameters that the user may engage with and thus may be recommended to the user.

Curation component 114 may be configured to identify a curation of the pieces of content and the new pieces of content that are similar to the first set of the pieces of content and/or are characterized with similar ones of the content parameter values. Identification of the curation may be based on the psychological profile of the user, the correlations, the new pieces of content, and/or other information. Determining similarity may include determining a defined amount of the content parameter values to the content parameters that are identical, whether a majority of the content parameter values to the content parameters are similar (e.g., within individual similar ranges), and/or other determination of similarity. The defined amount of the content parameter values to the content parameters that are identical may be specified by an administrative user of system 100, may be a fixed amount, percentage, and/or portion, may be modifiable by the administrative user, and/or other defined amount. In some implementations, the curation may be a minimum amount of pieces of content. In some implementations, the curation may be a maximum amount of pieces of content. The minimum and the maximum amounts may be predefined by system 100 and/or modifiable by the administrative user, fixed, or modifiable by the users.

Profile determination component 116 may be configured to determine a first set of psychological parameter values to psychological parameters based on the correlations, the second set of the pieces of content, and/or other information. That is, given that the correlations are between content parameter values and psychological parameter values, the correlations that involve the content parameter values of the second set of the pieces of content may be utilized to determine the correlated psychological parameter values, i.e., the first set of psychological parameter values. Subsequently, profile determination component 116 may be configured to identify a set of users associated with psychological profiles that includes at least some of the first set of psychological parameter values. Meaning, given the first set of psychological parameter values, particular ones of the psychological profiles that include at least some of the first set of psychological parameter values may be identified, and thus the set of users associated with those particular psychological profiles may be identified. This set of users identified may be determined to engage with or otherwise appreciate the one or more new pieces of content included in the content recommendation request.

Presentation component 118 may be configured to effectuate presentation of the curation to the user via client computing platform 104 associated with the user. The curation may include or be presented with previews of the content, links that direct the user to the content upon selection, and/or other presentations of the curation. In some implementations, effectuating presentation of the curation may include presenting the curation via a content account and/or other account. The content account may be coupled to the digital environments and/or the online platforms that provide the digital environments where the curations presented may comprise the content from one or more of the digital environments coupled to. Thus, the associated user to the content account may receive a comprehensive curation of all the digital environments they interact with in one digital place.

Presentation component 118 may be configured to effectuate presentation of a recommendation curation to client computing platforms 104 associated with the set of users. The recommendation curation may include the one or more pieces of new content and/or other content recommended. In some implementations, effectuating presentation of the recommendation curation may include presenting the recommendation curation via the content accounts associated with the users as described herein.

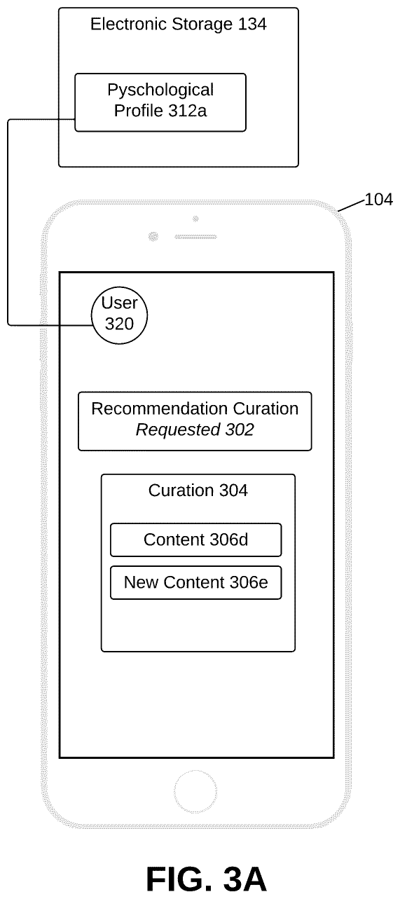

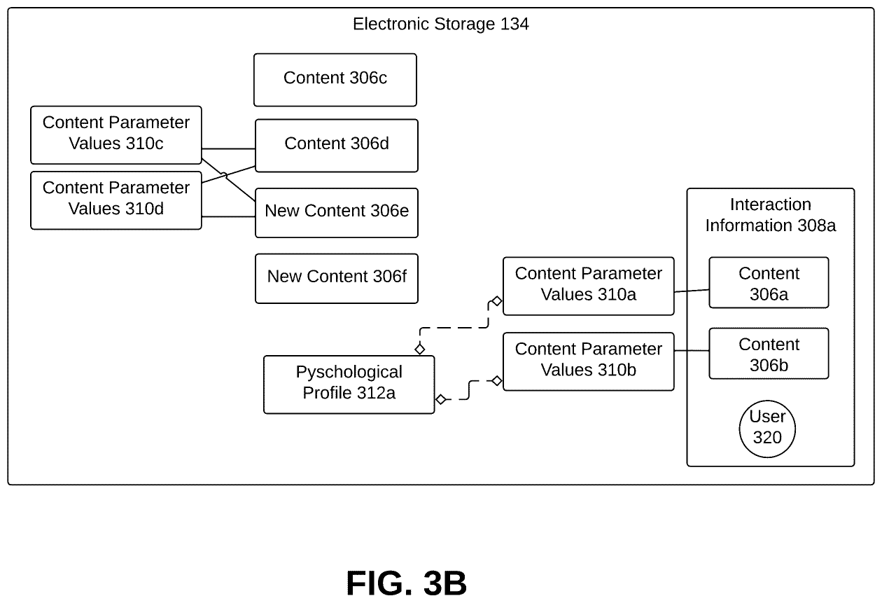

FIG. 3A illustrates a client computing platform 104 for a user 320. User 320 may be associated with a psychological profile 312a in electronic storage 134 that characterizes psychological attributes of user 320. User 320, via client computing platform 104, may submit a recommendation curation request 302 that request for a curation 304 of recommended content for various digital environments.

FIG. 3B illustrates electronic storage 134. Electronic storage 134 may store interaction information 308a that includes content 306a and 306b that user 320 has engaged with. Content 306a and 306b may be defined by content parameter values 310a and content parameter values 310b, respectively. Electronic storage 134 may additionally store new content 306e and 306f received from online platforms (not illustrated) that provide or host digital environments, and content 306c and content 306d. Content 306c-f may be defined by respective content parameter values. Responsive to receipt of recommendation curation request 302 in FIG. 1, content parameter values 310a and 310b may be determined by way of interaction information 308a. Subsequently, content parameter values 310a and 310b may be correlated with psychological profile 312a (the same as in FIG. 3A that user 320 is associated with) of stored in electronic storage 134. Thus, based on psychological profile 312a, content parameter values 310a and 310b correlated with psychological profile 312a, and the content parameter values that define content 306c-f, content parameter values 310c and 310d may be particularly identified as similar to content parameter values 310a and 310b. Thus, content 306d and new content 306e defined by one or more of content parameter values 310a and 310b may be identified for and included in curation 304 in FIG. 3A. Curation 304 may be presented to user 320 via client computing platform 104.

Referring back to FIG. 1, in some implementations, server(s) 102, client computing platform(s) 104, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 132 may be operatively linked via some other communication media.

A given client computing platform 104 may include one or more processors configured to execute computer program components. The computer program components may be configured to enable an expert or user associated with the given client computing platform 104 to interface with system 100 and/or external resources 132, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Server(s) 102 may include electronic storage 134, one or more processors 136, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 134 may comprise non-transitory storage media that electronically stores information. The electronic storage media of electronic storage 134 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from server(s) 102, information received from client computing platform(s) 104, and/or other information that enables server(s) 102 to function as described herein.

Processor(s) 136 may be configured to provide information processing capabilities in server(s) 102. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute components 108, 110, 112, 114, 116, and/or 118, and/or other components. Processor(s) 136 may be configured to execute components 108, 110, 112, 114, 116, and/or 118, and/or other components by software; hardware; firmware; some combination of software, hardware, and/or firmware; and/or other mechanisms for configuring processing capabilities on processor(s) 136. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and/or 118 are illustrated in FIG. 1 as being implemented within a single processing unit, in implementations in which processor(s) 136 includes multiple processing units, one or more of components 108, 110, 112, 114, 116, and/or 118 may be implemented remotely from the other components. The description of the functionality provided by the different components 108, 110, 112, 114, 116, and/or 118 described below is for illustrative purposes, and is not intended to be limiting, as any of components 108, 110, 112, 114, 116, and/or 118 may provide more or less functionality than is described. For example, one or more of components 108, 110, 112, 114, 116, and/or 118 may be eliminated, and some or all of its functionality may be provided by other ones of components 108, 110, 112, 114, 116, and/or 118. As another example, processor(s) 136 may be configured to execute one or more additional components that may perform some or all of the functionality attributed below to one of components 108, 110, 112, 114, 116, and/or 118.

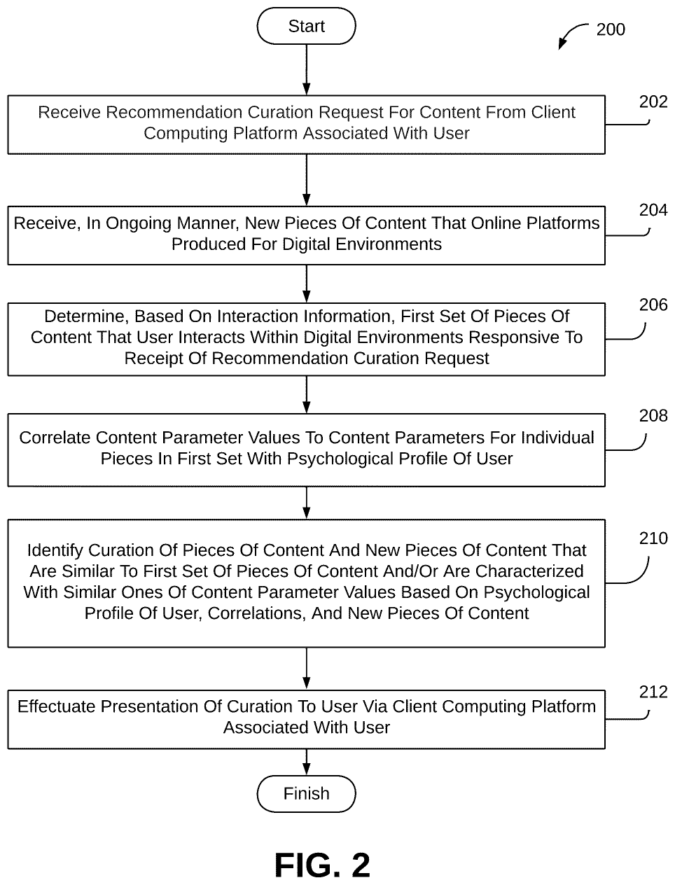

FIG. 2 illustrates a method 200 to analyze and identify effective content for a curation in digital environments, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving a recommendation curation request for content from a client computing platform associated with a user. Operation 202 may be performed by one or more hardware processors configured by machine-readable instructions including a component that is the same as or similar to curation request component 108, in accordance with one or more implementations.

An operation 204 may include receiving, in an ongoing manner, new pieces of content that online platforms produced for the digital environments. The new pieces of content are characterized by content parameter values to content parameters. Operation 204 may be performed by one or more hardware processors configured by machine-readable instructions including a component that is the same as or similar to content determination component 110, in accordance with one or more implementations.

An operation 206 may include determining, based on interaction information, a first set of the pieces of content that the user interacts within the digital environments responsive to receipt of the recommendation curation request. Operation 206 may be performed by one or more hardware processors configured by machine-readable instructions including a component that is the same as or similar to content determination component 110, in accordance with one or more implementations.

An operation 208 may include correlating the content parameter values to the content parameters for individual pieces in the first set with the psychological profile of the user. Operation 208 may be performed by one or more hardware processors configured by machine-readable instructions including a component that is the same as or similar to correlation component 112, in accordance with one or more implementations.

An operation 210 may include identifying a curation of the pieces of content and the new pieces of content that are similar to the first set of the pieces of content and/or are characterized with similar ones of the content parameter values based on the psychological profile of the user, the correlations, and the new pieces of content. Operation 210 may be performed by one or more hardware processors configured by machine-readable instructions including a component that is the same as or similar to curation component 114, in accordance with one or more implementations.

An operation 212 may include effectuating presentation of the curation to the user via a client computing platform associated with the user. Operation 212 may be performed by one or more hardware processors configured by machine-readable instructions including a component that is the same as or similar to presentation component 118, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to analyze and identify effective content for a curation in digital environments, the system including:
electronic storage configured to store i) psychological profiles for users, ii) pieces of content provided by digital environments, and iii) interaction information, wherein the psychological profiles include the psychological parameter values to the psychological parameters, wherein the pieces of content are characterized by the content parameter values to the content parameters, wherein the interaction information characterizes interactions between the users and the pieces of content via the digital environments and/or engagement by the users with the pieces of content;
one or more processors configured by machine-readable instructions to:
receive a recommendation curation request for content from a client computing platform associated with a user;
receive, in an ongoing manner, new pieces of content that online platforms produced for the digital environments, wherein the new pieces of content are characterized by the content parameter values to the content parameters;
determine, based on the interaction information, a first set of the pieces of content that the user interacts within the digital environments responsive to receipt of the recommendation curation request;
correlate the content parameter values to the content parameters for individual pieces in the first set with the psychological profile of the user;
identify a curation of the pieces of content and the new pieces of content that are similar to the first set of the pieces of content and/or are characterized with similar ones of the content parameter values based on the psychological profile of the user, the correlations, and the new pieces of content; and
effectuate presentation of the curation to the user via a client computing platform associated with the user.

2. The system of claim 1, wherein the recommendation curation request from the user specifies an objective of the request.

3. The system of claim 2, wherein the objective includes engaging content, health content, active content, multiplayer content, single player content, reoccurring content, and/or educational content.

4. The system of claim 1, wherein the recommendation curation request is received in a reoccurring manner, wherein the reoccurring manner includes every day, every month, every week, or every particular amount of days.

5. The system of claim 1, wherein effectuating presentation of the curation includes presenting the curation via a content account, where the content account is coupled to the digital environments.

6. A system configured to analyze and identify prospective psychological profiles to generate a curation of prospective contents for, the system including:
electronic storage configured to store i) psychological profiles for users, ii) pieces of content provided by digital environments, iii) interaction information, and iv) correlations between content parameter values to content parameters for individual ones of the pieces of content and psychological parameter values to psychological parameters of the users, wherein the psychological profiles include the psychological parameter values to the psychological parameters, wherein the pieces of content are characterized by the content parameter values to the content parameters, wherein the interaction information includes the pieces of content that the users interact with and how the users interact with such;
one or more processors configured by machine-readable instructions to:
receive a content recommendation request from a client computing platform associated with a creator of one or more pieces of new content, wherein the content recommendation request includes the one or more pieces of new content to recommend to appropriate ones of the users;
determine content parameter values to the content parameters for the one or more pieces of new content;
determine, based on the interaction information and the content parameter values to the content parameters, a set of the pieces of content that are similar to the one or more pieces of new content;
determine, based on the correlations and the set of the pieces of content, a first set of psychological parameter values to psychological parameters;
identify a set of users associated with psychological profiles that includes at least some of the first set;
effectuate presentation of a recommendation curation to client computing platforms associated with the set of users, wherein the recommendation curation includes the one or more pieces of new content.

7. The system of claim 6, wherein determining the content parameter values includes receiving the content parameter values from the client computing platform associated with the creator.

8. The system of claim 6, wherein effectuating presentation of the recommendation curation includes presenting the recommendation curation via a content account, where the content account is coupled to the digital environments.

9. The system of claim 6, wherein the pieces of new content include virtual content, physical products, services, and/or subscription plans.

10. A method to analyze and identify effective content for a curation in digital environments, the method including:
receiving a recommendation curation request for content from a client computing platform associated with a user, wherein an electronic storage is configured to store i) psychological profiles for users, ii) pieces of content provided by digital environments, and iii) interaction information, wherein the psychological profiles include the psychological parameter values to the psychological parameters, wherein the pieces of content are characterized by the content parameter values to the content parameters, wherein the interaction information characterizes interactions between the users and the pieces of content via the digital environments and/or engagement by the users with the pieces of content;
receiving, in an ongoing manner, new pieces of content that online platforms produced for the digital environments, wherein the new pieces of content are characterized by the content parameter values to the content parameters;
determining, based on the interaction information, a first set of the pieces of content that the user interacts within the digital environments responsive to receipt of the recommendation curation request;
correlating the content parameter values to the content parameters for individual pieces in the first set with the psychological profile of the user;
identifying a curation of the pieces of content and the new pieces of content that are similar to the first set of the pieces of content and/or are characterized with similar ones of the content parameter values based on the psychological profile of the user, the correlations, and the new pieces of content; and
effectuating presentation of the curation to the user via a client computing platform associated with the user.

11. The method of claim 10, wherein the recommendation curation request from the user specifies an objective of the request.

12. The method of claim 11, wherein the objective includes engaging content, health content, active content, multiplayer content, single player content, reoccurring content, and/or educational content.

13. The method of claim 10, wherein the recommendation curation request is received in a reoccurring manner, wherein the reoccurring manner includes every day, every month, every week, or every particular amount of days.

14. The method of claim 10, wherein effectuating presentation of the curation includes presenting the curation via a content account, where the content account is coupled to the digital environments.

15. A method to analyze and identify prospective psychological profiles to generate a curation of prospective contents for, the method including:
receiving a content recommendation request from a client computing platform associated with a creator of one or more pieces of new content, wherein the content recommendation request includes the one or more pieces of new content to recommend to appropriate ones of the users, wherein an electronic storage is configured to store i) psychological profiles for users, ii) pieces of content provided by digital environments, iii) interaction information, and iv) correlations between content parameter values to content parameters for individual ones of the pieces of content and psychological parameter values to psychological parameters of the users, wherein the psychological profiles include the psychological parameter values to the psychological parameters, wherein the pieces of content are characterized by the content parameter values to the content parameters, wherein the interaction information includes the pieces of content that the users interact with and how the users interact with such;
determining content parameter values to the content parameters for the one or more pieces of new content;
determining, based on the interaction information and the content parameter values to the content parameters, a set of the pieces of content that are similar to the one or more pieces of new content;
determining, based on the correlations and the set of the pieces of content, a first set of psychological parameter values to psychological parameters;
identifying a set of users associated with psychological profiles that includes at least some of the first set;
effectuating presentation of a recommendation curation to client computing platforms associated with the set of users, wherein the recommendation curation includes the one or more pieces of new content.

16. The method of claim 15, wherein determining the content parameter values includes receiving the content parameter values from the client computing platform associated with the creator.

17. The method of claim 15, wherein effectuating presentation of the recommendation curation includes presenting the recommendation curation via a content account, where the content account is coupled to the digital environments.

18. The method of claim 15, wherein the pieces of new content include virtual content, physical products, services, and/or subscription plans.
